(19) United States
(12) Patent Application Publication
(10) Pub. No.: US 2019/0067926 A1
(43) Pub. Date: Feb. 28, 2019

(54) METHODS AND APPARATUS FOR APPLICATION OF GLUE DOTS TO SECURE COMMUNICATION LINES

(71) Applicant: COMMSCOPE TECHNOLOGIES LLC, Hickory, NC (US)

(72) Inventor: Michael James OTT, Hudson, WI (US)

(21) Appl. No.: 16/081,813

(22) PCT Filed: Mar. 1, 2017
(86) PCT No.: PCT/US17/20193

§ 371 Date: Aug. 31, 2018

Related U.S. Application Data
(60) Provisional application No. 62/302,615, filed on Mar. 2, 2016.

(51) Int. Cl. H02G 3/30

(52) U.S. Cl. CPC H02G 3/305; H02G 1/06

(57) ABSTRACT

Aspects and techniques of the present disclosure relate to a process of installing communication line by adhering glue dots to a surface and mounting the communication line onto the glue dots. Further, apparatus and features thereof are characterized.

### CROSS-REFERENCE TO RELATED APPLICATION

This application is being filed on Mar. 1, 2017 as a PCT International Patent Application and claims the benefit of U.S. Patent Application Ser. No. 62/302,615, filed on Mar. 2, 2016, the disclosure of which is incorporated herein by reference in its entirety.

### TECHNICAL FIELD

The present disclosure relates generally to the installation of wires and/or cables in interior spaces and more particularly, relates to a method and apparatus for adhering cables and wires, such as fiber optic cable, to walls, trim and ceilings in either the interior or exterior of residential and business establishments.

### BACKGROUND

The move from traditional copper or coax wiring to fiber optic cable and wires for providing telephone, Internet, television, security, home automation control and other low voltage applications is fast becoming the norm. The use of this new technology, however, requires the installation of fiber optic cables and/or individual fiber optic wires and connectors in homes and business establishments. In the case of new construction, this is not a problem but in the case of existing structures, it is not always easy and in fact is sometimes very difficult or impossible to run fiber optic wire within the walls of an existing structure.

In some residential complexes such as apartments and also in business units such as offices and other commercial establishments, it is much more desirable to provide a larger fiber optic cable within a common area such as a hallway, stairway or the like and then to run individual wires within each apartment. Not only is this at times the only feasible way of getting fiber optic wires and/or cables within a pre-existing and already constructed building but in addition, an added benefit is the ability to terminate a fiber optic wire wherever the resident/occupant desires within their apartment or business space such as in individual rooms or offices.

Landlords, however, are reluctant to allow of the permanent installation of wires on apartment walls or ceilings or even on the exterior of a structure for fear that they will either damage the apartment or provide an unsightly wire configuration. In addition, if the next tenant wishes to have the wires located in a different place (for example on a different wall in a living room), the removal of the wiring installed by or on behalf of the previous tenant may cause damage to the walls or ceilings while mechanical fasteners presently used will also damage the walls or woodwork.

Accordingly, what is needed is a system and method to allow an installer to quickly and easily install, either preferably at the ceiling level (the interface between the wall and the ceiling) or along the floorboard, a communication line, and wherein such communication line can be adhered to the wall or ceiling with an adhesive that is inherently unobtrusive in appearance on a backing film or liner, easily applied, and clean (non-flowing) without leaving a residue (or with minimal residue) or without damaging the walls or ceilings, and which communication line is repositionable if desired.

Improvements in adhering communication lines for final placement in fiber to premise applications are desirable.

### SUMMARY

Applicator devices and features thereof are described. Also described are methods of installation of communications lines and final placement thereof. The communications line can include a copper cable, fiber optic cable, a bare fiber, a coated fiber, a buffered fiber. While the examples discussed herein are with reference to a communication line, the present disclosure also applies to attaching other types of cables such as electrical power cables or electrical communication cables.

One aspect of the present disclosure relates to a method of installing a communications line to a surface. The method can include a step of applying a flexible carrier material that includes a series of glue dots against the surface; a step of removing the flexible carrier material from the surface, the series of glue dots remaining secured to the surface and protruding therefrom to form line receiving posts; and a step of securing the communications line onto the line receiving post of the series of glue dots positioned on the surface.

Another aspect of the present disclosure relates to a method of mounting a communications line to a surface. The method can include a step of applying glue dots to a surface; and a step of securing the communications line to at least a portion of the glue dots applied on the surface.

A further aspect of the present disclosure relates to a handheld glue dot dispense apparatus. The handheld glue dot dispense apparatus can comprise a roller that is configured, in use, to apply and press a series of glue dots into a corner between a wall and ceiling surface. The roller can include an apex portion that is a point where a diameter of the roller is largest to press into the corner along a desired surface between the wall and ceiling; and a first angled surface and an opposite, second angled surface being positioned on opposing sides of the apex portion.

### BRIEF DESCRIPTION OF THE DRAWINGS

FIG. 1 is a perspective schematic fragmentary view depicting a series of glue dots located in a corner between two surfaces and a flexible carrier material affixed to one of the surfaces in accord with the principles of the present disclosure.

FIG. 2 is a perspective schematic fragmentary view showing the flexible carrier material removed and a group of glue dots remaining.

FIG. 3 is an enlarged perspective schematic fragmentary view of a portion of FIG. 1 showing the glue dots aligned in the corner.

FIG. 4 is a perspective schematic fragmentary view of FIG. 3 depicting a communications line secured to the glue dots.

FIG. 5 is a top schematic view of a first example hand tool for aligning and mounting the glue dots and for final placement of the communications line in accord with the principles of the present disclosure.

FIG. 6 is a side schematic view of an exemplary apex roller supported in a mounting support member.

FIG. 7 is a front schematic view of the mounting support member shown in FIG. 6.

FIG. 8 is a front schematic view of the apex roller shown in FIG. 6 as mounted in the mounting support member.

FIG. 9 is a rear schematic view of the mounting support member shown in FIG. 8.

FIG. 10 is a front schematic view of a second example hand tool for aligning and mounting the glue dots and for final placement of the communications line in accord with the principles of the present disclosure.

FIG. 11 is a rear schematic view of the second example hand tool shown in FIG. 10.

FIG. 12 is a perspective view showing one end of the second example hand tool of FIG. 10 being applied to the flexible carrier material.

FIG. 13 is a perspective view showing another end of the second example hand tool of FIG. 10 being applied to the communications line on the glue dots.

### DETAILED DESCRIPTION

It is an object of the present disclosure to provide a novel technique and structure for accurately, but quickly, mounting a communication line in fiber to premise applications. It is a further object to provide a dispense apparatus capable of dispensing flexible carrier material including glue dots which is of a configuration to facilitate mounting of a communication line on a support structure (e.g., walls, baseboards, corners, etc.). The glue dotes are precisely aligned and positioned on one side of the flexible carrier material to be adhered to the support structure as desired.

This disclosure relates generally to methods for dispensing adhesive, and more particularly to a method and apparatus for applying a quantity of pressure sensitive adhesive material in the form of glue dots to a surface for enabling the communication line to be secured to the glue dots on the surface.

The principles, techniques, and features described herein can be applied in a variety of installation methods, and there is no requirement that all of the advantageous features identified be incorporated in an assembly, system or component to obtain some benefit according to the present disclosure.

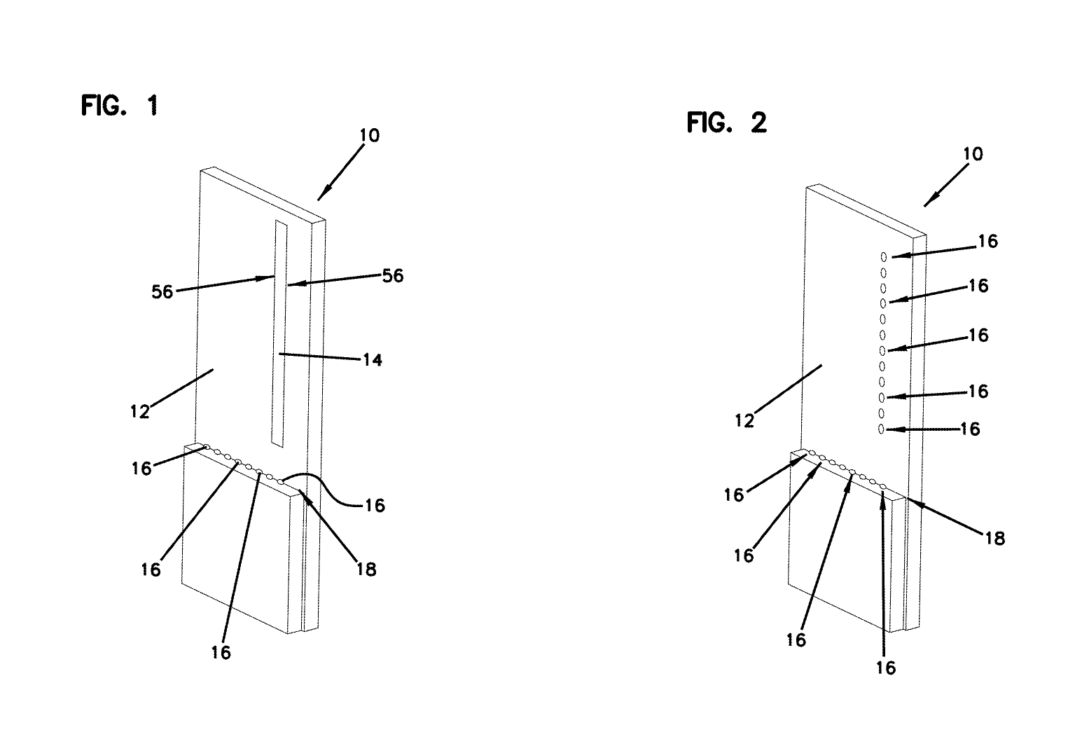

FIG. 1 shows an example mounting structure 10 (e.g., wall, baseboard, etc.) including a surface 12 to which a carrier material 14 is applied. The carrier material 14 may be a strip of flexible plastic or polymeric film, alternatives are possible. One side of the carrier material 14 may be silicone treated in a conventional manner to enable release of the carrier material 14 from surfaces adhered to in a manner to be described. On the treated side of the carrier material 14, a number of glue dots 16 (e.g., adhesive dots) can be mounted thereon. The glue dots 16 are to be transferred from the carrier material 14 and applied to the surface 12 of the mounting structure 10. The glue dots 16 are made of a pressure sensitive material.

A cloth or similar material can be used to wipe down the surface 12 prior to applying the carrier material 14. The cloth can be lightly damped with water to remove any contaminates from the surface, such as, dust or dirt. After the surface 12 is allowed to dry, the carrier material 14 can be applied over a portion of the surface 12 to which the glue dots 16 are to be transferred and applied. The carrier can be in a roll or web form such that only a desired length of the carrier material 14 can be applied and the outside thereof has a greater release characteristic than the inner side to allow the roll or web to be unwound. The carrier material 14 can be pressed by hand, although alternatives are possible, onto the surface 12 such that the glue dots are secured to the surface 12. It is not necessary to press firmly along the desired length of the carrier material 14. One end of the carrier material 14 can be held to keep the desired placement as the carrier material 14 is applied.

The carrier material 14 can be removed from the surface 12 by pulling one end thereof in close proximity to fingertips away from the surface 12. Upon pulling the carrier material 14 away, the glue dots 16 remain secured on the surface 12 as shown in FIG. 2 and is released from the carrier material 14. In this manner, the glue dots 16 can be applied to the surface 12 in any desired pattern or configuration. For example, the glue dots 16 may be placed continuously along a desired length. The glue dots 16 may be placed intermittently in lengths of at least 1 to 6 inches that can be spaced at least 1 foot apart, although alternatives are possible.

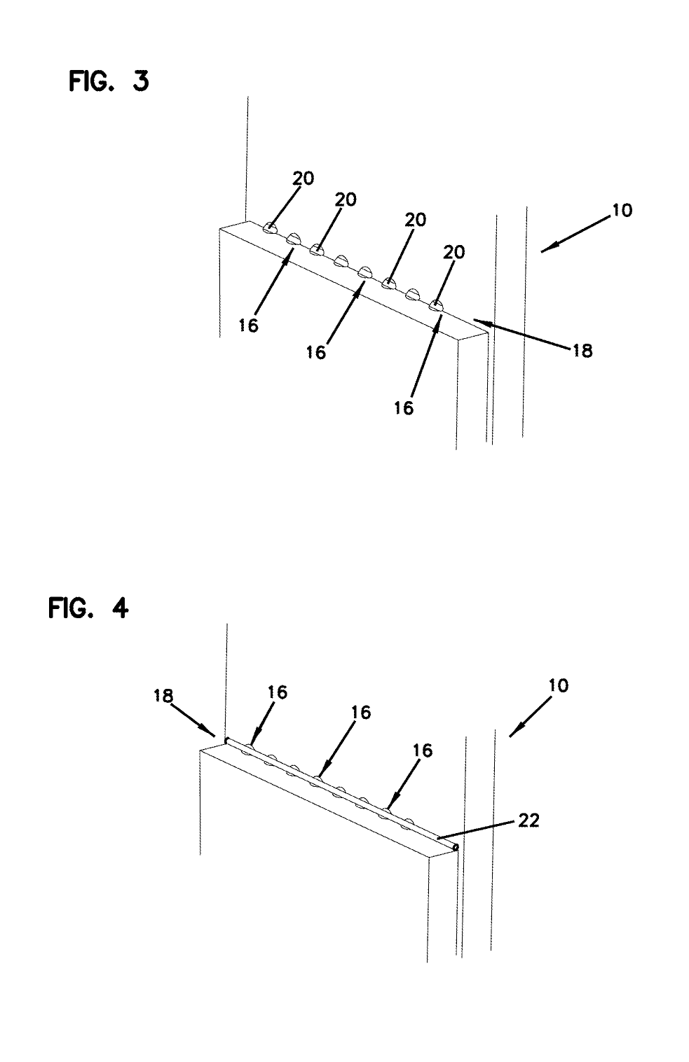

The glue dots 16 may be applied in a corner 18 as depicted in FIG. 3. In such a configuration, the carrier material 14 can be partially folded in half such that the glue dots 16 can be easily secured in the corner 18. The glue dots 16 protrude from the surface 12 to form line receiving posts 20. A communication line 22 (e.g., fiber optic wire, fiber optic cable, bare fiber, coated fiber, buffered fiber, copper cable) can be placed on the line receiving posts 20 of the glue dots 16. The communication line 22 can be pressed to tack or secure the communication line 22 in place. The communication line 22 may be repositioned if desired. Once the communication line 22 is in its final placement, the communication line 22 can be pressed into each one of the glue dots 16.

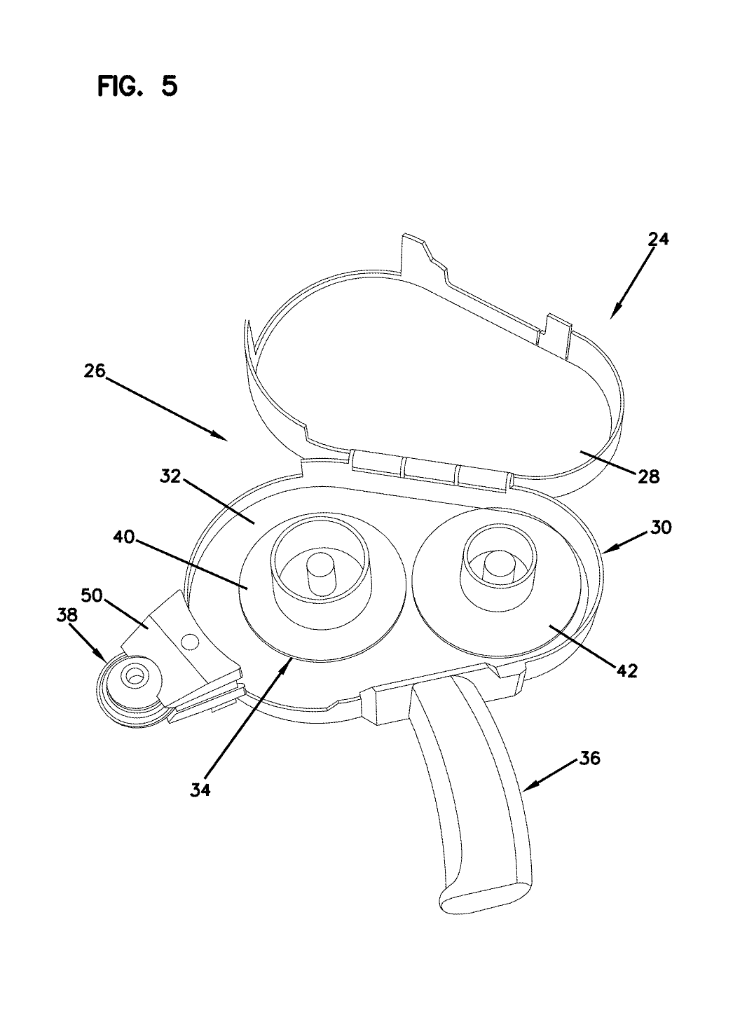

Referring to FIG. 5, an example handheld glue dot dispense apparatus 24 is depicted. The handheld glue dot dispense apparatus 24 can be used for applying the carrier material 14 and glue dots 16 in the manner described above. The handheld glue dot dispense apparatus 24 can include a housing 26 having a cover 28 and a base 30. The cover 28 can be pivotally mounted or hinged to the base 30, although alternatives are possible. The base 30 defines a cavity 32 for housing a dispense mechanism 34 that dispenses the carrier material 14. The handheld glue dot dispense apparatus 24 can also include a handle 36 that is attached to the base 30 of the housing 26.

The housing 26 of the handheld glue dot dispense apparatus 24 can have a ceramic construction. The housing 26 of the handheld glue dot dispense apparatus 24 can be made of alternative materials such as thermoplastic materials, for example, Polyphenylene sulfide (PPS), other engineering plastics or various metals.

The dispense mechanism 34 can include a roller 38, a supply spool 40 and a take up spool 42 (e.g., rewind spool) spaced from the supply spool 40. The supply spool 40 can retain a roll or web of the carrier material 14. The supply spool 40 is rotatable within the base 30 of the housing 26. The take up spool 42 takes the carrier material 14 from the supply spool 40 to be routed to the roller 38.

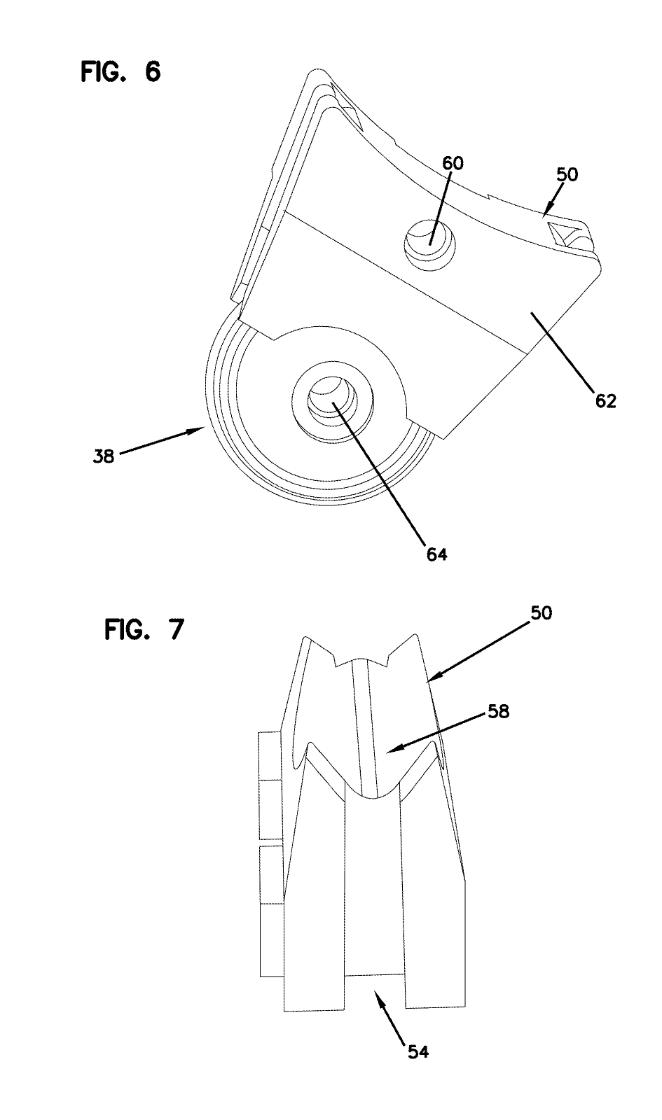

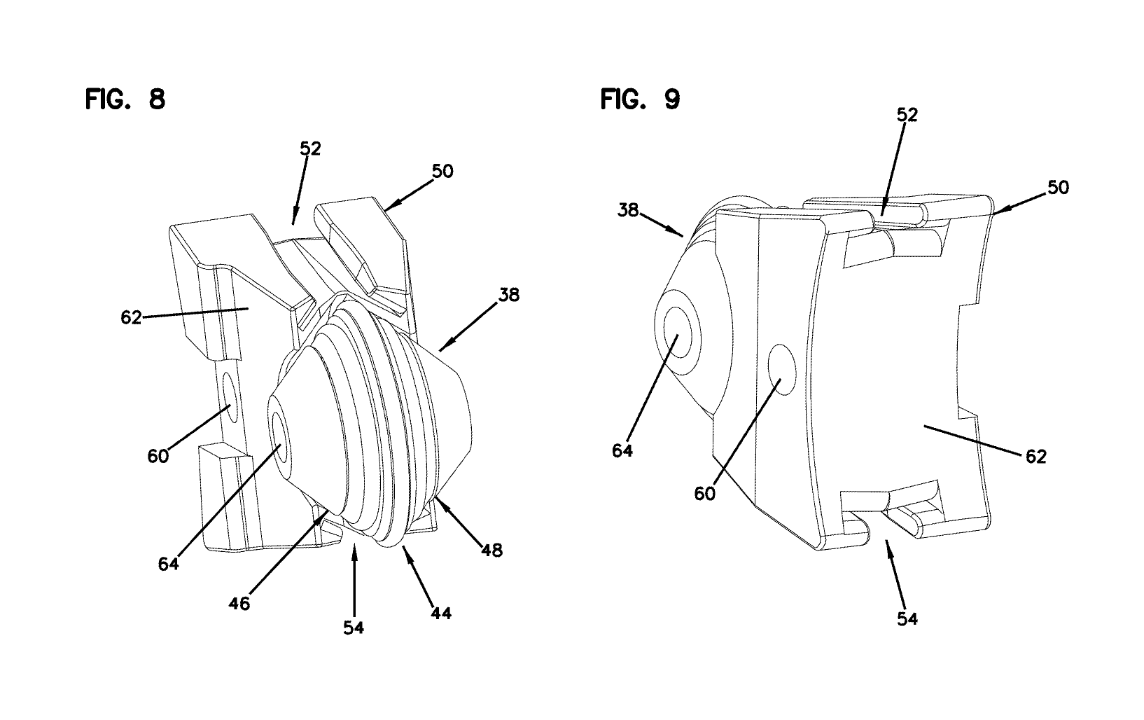

Referring to FIGS. 6-9, the roller 38 can include an apex portion 44 that is a point where a diameter of the roller 38 is largest such that the apex portion 44 can be used to press into the corner 18 when applying the carrier material 14 and the communication line 22. The roller 38 includes a first angled surface 46 and a second angled surface 48 that are respectively positioned on opposing sides of the apex portion 44. The first and second angled surfaces 46, 48 can be curved, although alternatives are possible. For example, the first and second angled surfaces 46, 48 can be flat.

The roller 38 can be supported by a mounting support member 50. The mounting support member 50 can be used to guide the carrier material 14 to the roller 38.

The mounting support member 50 incudes a transition supply slot 52 (see FIG. 9) and a transition take up slot 54 (see FIG. 9). The transition supply slot 52 is arranged and configured to transition the carrier material 14 from a flat shaped configuration to an apex configuration as the carrier material 14 is guided therethrough. The transition take up slot 54 is arranged and configured to transition the carrier material 14 from the apex configuration to the flat configuration as the carrier material is guided therethrough.

When the handheld glue dot dispense apparatus 24 is in use, the carrier material 14 can be guided over the take up spool 42 and passed out of the housing 26 through the transition supply slot 52 and over the roller 38 to the transition take up slot 54. A resilient flexible piece of material, such as rubber or the like, can be used as a pully to drive the supply and take up spools 40, 42. When the roller 38 is pressed against the surface 12, the glue dots 16 are transferred to the surface 12 in the manner previously described, thus being released from the carrier material 44. The handheld glue dot dispense apparatus 24 may be lifted during application of the carrier material 14 such that the glue dots 16 may be applied to the surface 12 in a desired pattern. The carrier material 14 can have edge portions 56 (see FIG. 1) that engage with opposing sides of the apex portion 44 of the roller 38 as the carrier material 14 is guided through the transition supply slot 52 and over the apex portion 44 of the roller 38.

The glue dots 16 can be positioned intermediate of the edge portions 56 of the carrier material 14. The mounting support member 50 can define a pocket 58 that includes an intermating apex profile such as that of the apex portion 44 of the roller 38. The roller 38 can be positioned within the pocket 58 to rotate therein as the carrier material 14 is dispensed. The pocket 58 is generally larger than the first and second angled surfaces 46, 48 of the roller 38. The mounting support member 50 defines an opening 60 that extends through a main body 62 of the mounting support member 50. The opening 60 is configured for receiving a mechanical fastener (not shown) for securing the mounting support member 50 to the handheld glue dot dispense apparatus 24.

The roller 38 defines an aperture 64 for receiving a mechanical fastener (not shown) therein for securing parts of the roller 38 together. The apex portion 44 of the roller 38 can be adapted to secure the glue dots 16 in the corner 18 and to press the communication line 22 to the glue dots 16.

The present disclosure also relates to a method of installing a communication line to a surface. The steps described herein are not all inclusive and may include other steps not shown. The steps described herein may also be performed in an alternative order. The method includes a step of 1) applying a carrier material 14 that includes a series of glue dots 16 against the surface; a step of 2) removing the carrier material 14 from the surface 12, the series of glue dots 16 remaining secured to the surface 12 protruding therefrom to form line receiving posts 20; and a step of 3) securing the communication line 22 onto the line receiving post 20 of the series of glue dots 16 positioned on the surface 12.

The present disclosure also relates to a method of mounting a communication line 22 to the surface 12. The steps described herein are not all inclusive and may include other steps not shown. The steps described herein may also be performed in an alternative order. The method includes a step of 1) applying the glue dots 16 to the surface 12; and a step of 2) securing the communication line 22 to at least a portion of the glue dots 16 applied on the surface 12.

The process of installing the communication line 22 to a surface 12 may also include the following steps: 1) wipe down the surface 12 with cloth lightly, the cloth may be dampened with water to remove most dust or dirt, then allow the surface 12 to dry; 2) pull off desired length of the carrier material 14 including the glue dots 16; 3) if placing into the corner 18, pinch the carrier material 14 to partially fold the carrier material 14 in half with the glue dots 16 on the outside; 4) place the carrier material 14 into desired corner 18 or surface 12, do not press firmly along the length; 5) use a fingertip, pen tip, or roller tool to press carrier material 14 and/or glue dot 16 onto the surface 12 and/or into the corner 18; 6) simultaneously begin sliding fingertip, pen tip, or roller tool along carrier material 14, pulling carrier material 14 off already placed/pressed glue dots 16 in close proximity to fingertip, pen tip, or roller tool; 7) initially place communication line 22 at center of glue dots 16—or in corner 18 if corner application; 8) press communication line 22 onto the glue dots 16 occasionally to “tack” the communication line 22 in place; and 9) go along the length and press the communication line 22 into each glue dot 16. The steps of the described are not all inclusive and may include other steps not shown. The steps described herein may also be performed in an alternative order.

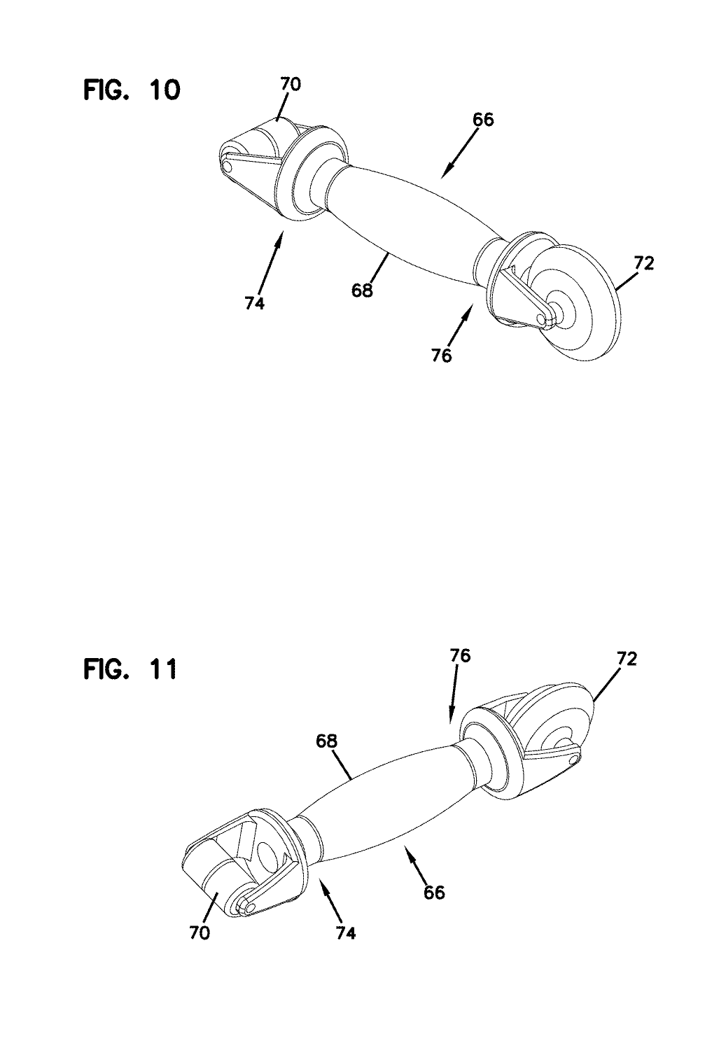

Referring to FIGS. 10-13, a roller tool 66 can assist this if desired. The roller tool 66 can be oriented such that the carrier material 14 is centered on the desired surface or over a corner. The roller tool 66 can be rolled along a desired surface to dispense the glue dotes 16 as desired. The trajectory of the roller tool 66 can be adjusted to direct dispensing of the glue dots 16 as desired. The roller tool 66 may be lifted during application of the carrier material 14 to obtain a desired pattern of glue dots 16.

The roller tool 66 has a first end 74 and a second end 76. The roller tool 66 can include a handle portion 68, a flat roller 70 at the first end 74, an apex roller 72 at the second end 76 and a handle portion 68 positioned between the first and second ends 74, 76. The flat roller 70 can be used to apply the carrier material 14 or communication line 22 on a surface 12 and the apex roller 72 can be used to apply the carrier material 14 or communication line 22 into the corner 18.

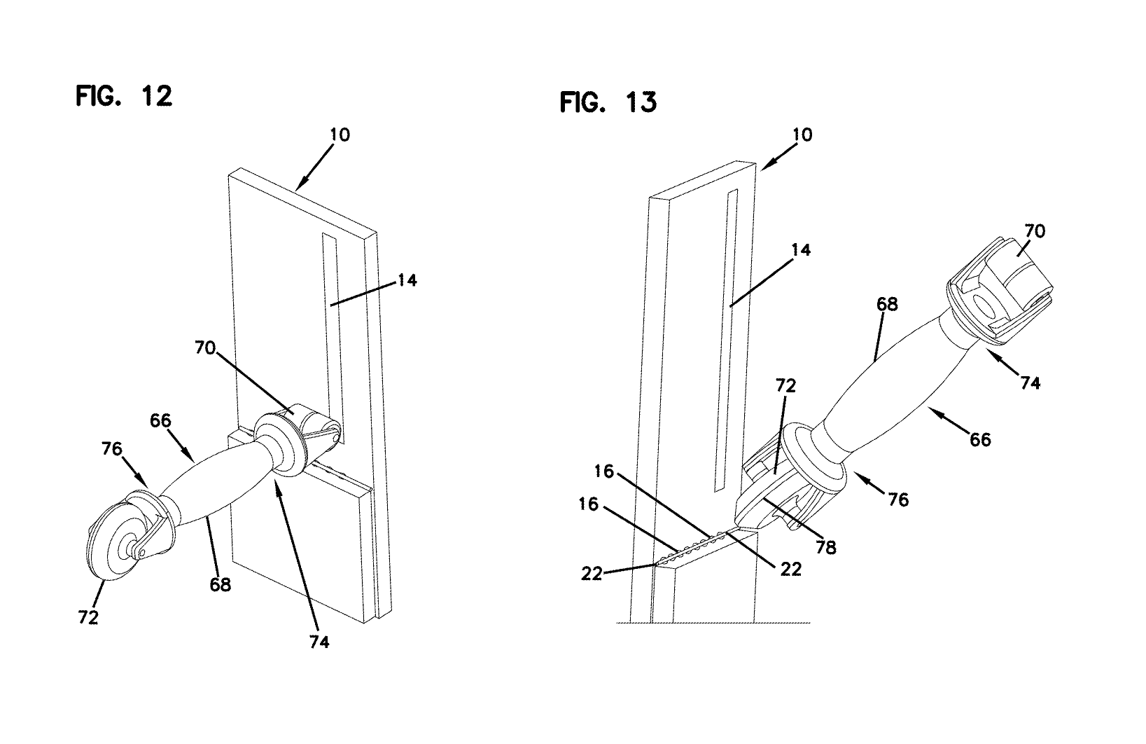

As depicted in FIG. 12, the roller tool 66 can assist with glue dot 16 adhesion and removal of the carrier material 14. As the roller tool 66 is being rolled across the carrier material 14, the carrier material 14 can be removed simultaneously leaving behind the glue dots 16 secured to the surface 12.

As depicted in FIG. 13, the apex roller 72 includes a slot 78 to help obtain a strong adhesion by pressing the communication line 22 onto the glue dots 16.

Aspects and techniques of the present disclosure relate to attaching communication lines generally. It will be appreciated that the aspects and techniques of the present disclosure can be applied in other applications, such as, electrical power cables or electrical communication cables.

From the forgoing detailed description, it will be evident that modifications and variations can be made without departing from the spirit and scope of the disclosure.

What is claimed is:

1. A method of installing a communication line to a surface; the method including:
(a) a step of applying a flexible carrier material that includes a series of glue dots against the surface;
(b) a step of removing the flexible carrier material from the surface, the series of glue dots remaining secured to the surface and protruding therefrom to form line receiving posts; and
(c) a step of securing the communication line onto the line receiving post of the series of glue dots positioned on the surface.

2. A method according to claim 1, wherein:
(a) the step of securing the communication line comprises:
(i) a step of pressing the communication line into each one of the line receiving post of the series of glue dots as desired.

3. A method according to claim 1, wherein:
(a) the step of applying the flexible carrier material is a step of placing the series of glue dots continuously along a length of the flexible carrier material.

4. A method according to claim 1, wherein:
(a) the step of applying the flexible carrier material is a step of placing the series of glue dots intermittently in lengths of at least 2 to 4 inches spaced at least 2 feet apart.

5. A method according to claim 1, including:
(a) a step of wiping down the surface to remove contaminates thereon before the step of applying the flexible carrier material.

6. A method according to claim 5, including:
(a) a step of drying the surface after the step of wiping down the surface.

7. A method according to claim 1, wherein:
(a) the step of applying the flexible carrier material includes rolling a press dispenser roller against the surface to obtain a desired pattern of the series of glue dots.

8. A method according to claim 1, wherein:
(a) the steps of applying and removing the flexible carrier material are by hand application.

9. A method according to claim 7, including:
(a) a step of lifting the press dispenser roller from the surface to attain a desired pattern of glue dots thereon during application of the flexible carrier material.

10. A method according to claim 1, wherein:
(a) the step of applying the flexible carrier material includes the series of glue dots being made of a pressure sensitive adhesive.

11. A method of mounting a communication line to a surface, the method comprising:
(a) a step of applying glue dots to a surface; and
(b) a step of securing the communication line to at least a portion of the glue dots applied on the surface.

12. A handheld glue dot dispense apparatus, comprising:
(a) a roller being configured, in use, to apply and press a series of glue dots into a corner between a wall and ceiling surface; the roller including:
(i) an apex portion that is a point where a diameter of the roller is largest to press into the corner along a desired surface between the wall and ceiling; and
(ii) a first angled surface and an opposite, second angled surface being positioned on opposing sides of the apex portion.

13. A handheld glue dot dispense apparatus according to claim 12, wherein:
(a) the first and second angled surfaces are curved.

14. A handheld glue dot dispense apparatus according to claim 12, wherein:
(a) the first and second angled surfaces are flat.

15. A handheld glue dot dispense apparatus according to claim 12, further comprising:
(a) a housing including a cover and a base, the base defining a cavity for housing a dispense mechanism that dispenses a flexible carrier material that carries glue dots; and
(b) a handle attached to the base of the housing.

16. A handheld glue dot dispense apparatus according to claim 15, wherein:
(a) the dispense mechanism includes:
(i) a supply spool to retain a roll of the flexible carrier material, the supply spool being rotatable within the base of the housing; and
(ii) a take up spool spaced from the supply spool, the take up spool taking the flexible carrier material from the supply spool to the roller.

17. A handheld glue dot dispense apparatus according to claim 15, wherein:
(a) the cover is hinged to the body.

18. A handheld glue dot dispense apparatus according to claim 15, wherein:
(a) the roller is supported by a mounting support member rotatably mounted to the base of the housing, the mounting support member includes a transition supply slot and a transition take up slot.

19. A handheld glue dot dispense apparatus according to claim 15, wherein:
(a) the flexible carrier material comprises a strip having edge portions engageable with opposing sides of the apex portion of the roller.

20. A handheld glue dot dispense apparatus according to claim 19, wherein:
(a) a series of glue dots are secured to one side of the strip of the flexible carrier material positioned intermediate of the edge portions thereof.

21. A handheld glue dot dispense apparatus according to claim 20, wherein:
(a) the series of glue dots are pressure sensitive adhesive dots.
